(19) United States
(12) Patent Application Publication
(10) Pub. No.: US 2008/0270375 A1
(43) Pub. Date: Oct. 30, 2008

(54) LOCAL NEWS SEARCH ENGINE

(75) Inventors: Srinivas NANDURI, San Francisco, CA (US); Amit GOSWAMI, San Mateo, CA (US)

Correspondence Address: THORNE & HALAJIAN;APPLIED TECHNOLOGY CENTER, 111 WEST MAIN STREET, BAY SHORE, NY, 11706, US

(73) Assignee: FRANCE TELECOM, Paris (FR)

(21) Appl. No.: 11/741,085

(22) Filed: Apr. 27, 2007

(51) Int. Cl. G06F 17/30

(52) U.S. Cl. 707/5; 707/E17.018; 707/E17.108

(57) ABSTRACT

The present system relates to a method for indexing a document comprising the acts of retrieving in the content of the document true landmarks associated with said content, selecting one true landmark as representing the document, indexing the document to include a reference to the selected true landmark, wherein the retrieving act further comprises the act of identifying landmarks through the comparison of the content of the document to a landmark database, and, retaining only true landmarks among the identified landmark using a natural language approach, and wherein the selecting act further comprising the acts of assigning a weight to each true landmark based on at least one criterion, selecting the true landmark that represents the document based on the assigned weights.

### FIELD OF THE PRESENT SYSTEM

The present system generally relates to search engine, and more specifically to local search engine that can accurately retrieve documents on the internet taking into account geographical parameters.

### BACKGROUND OF THE PRESENT SYSTEM

Today there is an explosion of information accessible through the Internet. Identifying specific information can sometimes become a real burden.

A plurality of search engines is currently available to help the user find and select hyperlinks to web pages with information relevant to him/her. Generally, a user will provide to a search engine a number of search terms, through a search query, that expresses his/her interests. The search engine will then return a list of links more or less relevant to the user's search query. The list of links, also called hits, is the result of the matching of the search terms with pre-stored web pages (collected e.g. through a web crawler). Some search engines may offer to rank the hits in terms of relevancy to the user.

By web crawler, one may understand a program or automated script which browses the World Wide Web in a methodical, and automated manner. The process is called Web crawling. Many sites, in particular search engines, use web crawling as a means of providing up-to-date data. Web crawlers are mainly used to create a copy of all the visited pages for later processing and indexing to authorize fast searches.

Local search engines are a specific type of search engines that attempt to return relevant web pages within a specific geographic region or location provided by the user. For example, a user may enter a local search query comprising a regular search query and add a location the hits should be related to. The local search engine will return relevant results, i.e. local information, such as links pertaining to the geographic region, businesses listed in the geographic region, or web pages whose content is about the geographic region.

To allow an efficient local search, webpages need to be indexed geographically based on the contents of the documents. Furthermore, location databases are readily available to match locations in the webpages content.

One interesting type of local information is local news. This is one of the most sought after information on TV, radio and the Internet. According to a study, USA alone has more than 10000 local information sources including local newspapers, magazines, journals, community portals, . . . which shows how significant this information is to people.

Some of the known search engines, such as Yahoo®, Google®, . . . offer local news pages with search engines so that a user can search local news. For a given location, web pages are generally crawled from sources local to said location, and regrouped in the local news page for this location. A user who wants to retrieve local news must find first the local news page, and then run a keyword search.

Some web portals, such as Topix.net, focus on categorizing local sources based on city or zip codes. They nevertheless do not separate global news from local sources.

WO2006074054A1 discloses a method of indexing webpages by retrieving location information, also called here after landmarks. Once a location is found, neighboring locations are identified and the webpage is indexed with the found location as well as the neighboring location. The described indexing method remains nonetheless limited in precision as one does not know whether the found location really characterize said page.

Locations may be ambiguous to recognize in a webpage content. When a plurality of locations is mentioned in a document content, it can be difficult to identify which location most characterizes the document.

Today this is a need for an indexing method that allows a sure determination of the landmarks found in a document. There is a further need for an indexing method that can identify the landmarks that really characterize a document. There is also a need for an efficient local search engine that can browse the indexed documents and achieve an improved local information retrieval.

### SUMMARY OF THE PRESENT SYSTEM

It is an object of the present system to overcome disadvantages and/or make improvements in the prior art.

To that extend, the present system proposes a search engine to identify documents both linked to a given landmark and satisfying a given search query from a plurality of documents, said architecture comprising:
a keyword indexing engine for generating a keyword indexing of the plurality of documents,
a landmark indexing engine operable, for each document, to:
   retrieve in the content of the document true landmarks associated with said document by matching the content of said document with a landmark database, and using a natural language approach to retain said true landmarks among the identified landmark,
   select at least one true landmark as representing the document by assigning a weight to each true landmark based on at least one criterion, and selecting said at least one true landmark that represents the document based on the assigned weights,
the landmark indexing engine being further operable to generate a landmark indexing for the plurality of documents by indexing each document with a reference to the selected at least one true landmark for said document,
a processor operable to identify the documents linked to the given landmark from the landmark indexing and satisfying the given search query from the keyword indexing.

The method according to the present system allows an efficient local search by marrying the features of a keyword search with a local search allowed thanks to a precise location indexing of documents. Each document is identified by the landmarks that truly characterize its content to facilitate the local search.

In accordance with an additional embodiment of the present system, the processor is further operable to:
retrieve the list of documents that satisfy the given search query,
select among the list of documents local documents that are referenced in the landmark indexing with at least one true landmark identical to the given landmark.

In accordance with an alternative embodiment of the present system, the query further comprises a distance to define a neighboring region around the given landmark, the processor being further operable to:
retrieve the list of documents that satisfy the given search query,
select among the list of documents local documents that are referenced in the landmark indexing with at least one true landmark located within the neighboring region.

The present system is also related to a processor for performing a local search.

In another embodiment of the present system, the present system proposes a method for indexing a document comprising the acts of:
retrieving in the content of the document true landmarks associated with said content by matching the content of said document with a landmark database, and using a natural language approach to retain said true landmarks among the identified landmark,
selecting at least one true landmark as representing the document by assigning a weight to each true landmark based on at least one criterion, and selecting said at least one true landmark that represents the document based on the assigned weights, and,
indexing the document to include a reference to the selected at least one true landmark.

In an additional embodiment of the method according to the present system, the documents are indexed for keywords.

In an additional embodiment of the method according to the present system, the selecting act further comprises a preliminary act of:
performing a semantic analysis of the document content to retain among the retrieved true landmarks the ones most relevant to said content.

In a further embodiment of the method according to the present system, the criterion takes into account at least one of:
the position of the true landmark in the document content,
the number of occurrences of the true landmark in the document content,
the type of the true landmark.

The present system is also related to a location indexing engine and a computer program implementing the location indexing method.

### BRIEF DESCRIPTION OF THE DRAWINGS

The present system is explained in further detail, and by way of example, with reference to the accompanying drawings wherein:

FIG. 1 shows an exemplary embodiment of the system according to the present system,

FIG. 2 shows a flow chart illustrating and exemplary embodiment of the method according to the present system,

FIG. 3 is an example of a document which is indexed by the indexing engine according to the present system, and;

FIG. 4 shows a flow chart illustrating a local search for documents based on the indexing method according to the present system.

### DETAILED DESCRIPTION OF THE PREFERRED EMBODIMENTS

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims.

For example, the present system allows an efficient indexing of documents in terms of geographic location, and is described here after in its application to web pages and web search engines. The man skilled in the art will notice that this is not the sole embodiment possible, and that the system and method according to the present system may be implemented to documents available on one or more databases, accessible through a local network. Other embodiments are readily available to the man skilled in the art.

Moreover, for the purpose of clarity, detailed descriptions of well-known devices, systems, and methods are omitted so as not to obscure the description of the present system. In addition, it should be expressly understood that the drawings are included for illustrative purposes and do not represent the scope of the present system.

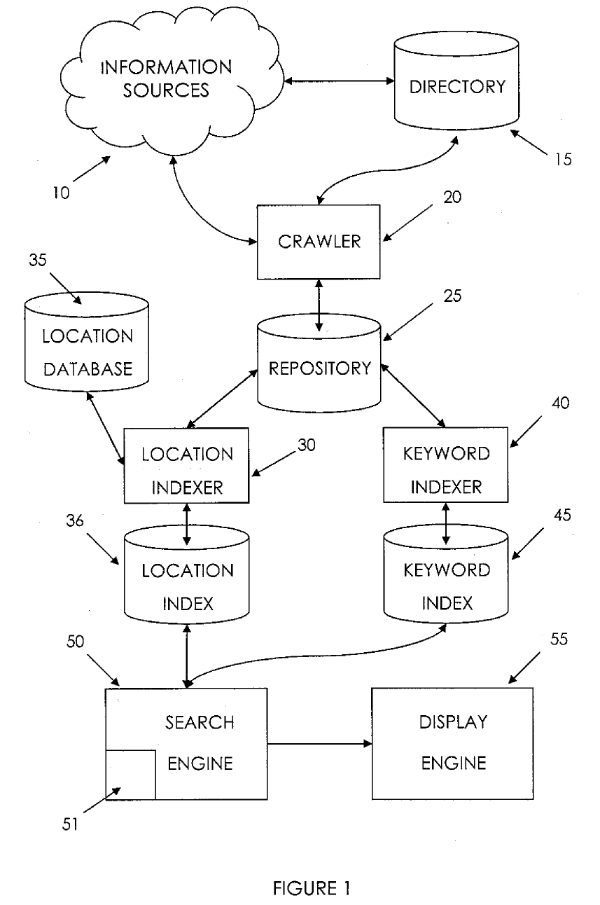

FIG. 1 shows an exemplary embodiment of the system according to the present system. Such a system comprises a directory of information sources and news 15, information sources 10, and a web crawler 20 to download pages to document repository 25. The system further comprises a location indexer 30 which performs the method according to the present system with the help of a location metadata repository 35. Documents are also indexed for other keywords through keyword indexer 40 and the help of an inverted keyword index 45. A search engine 50 receives a local query from a user and searches the document repository 25.

In the hereafter description, landmark and location will be used indifferently.

The directory of information sources and news 15 may comprise list of information sources 10 such as news papers, local and word wild, community journals, government websites, event portals, . . . or more generally any information sources that give a user access to information. The directory is not limited to a single entity, and may comprises e.g. a website, listing a plurality of sources, like available at www.onlinenewspapers.com, which gives access to a large list of newspapers websites through out the world, organized by continents and countries. Local sources may advertise themselves by registering to directory 15.

Web crawler 20 may access directory 15 to get the list of information sources 10 to crawl. All pages crawled are stored in a document repository 25. Various storage units are readily available to the man skilled in the art to embody document repository 25. Web crawler 20 may crawl the information sources periodically to update the content of the document repository 25.

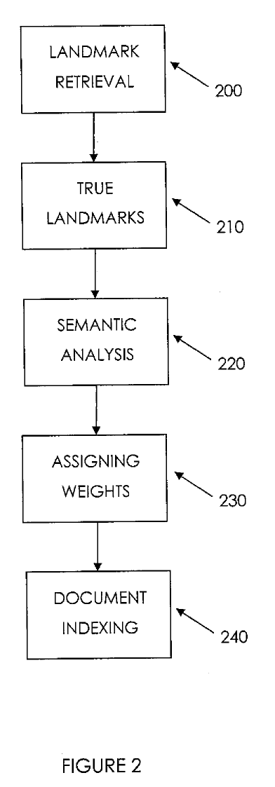

Location indexer 30, or location indexing engine, allows to retrieve and sort out the different landmarks, i.e. locations, comprises in the crawled pages. The method according to the present system will be described later on in relation to FIG. 2. Known locations are available through location database 35. Such information is available today to the man skilled in the art through the Gazetteer of the US Census Bureau (as available at http://www.census.gov/cgi-bin/gazetteer) which lists all US locations and related zip codes. Other sources may include Geonames (such as available at www.geonames.org) which contains over eight million geographical names or landmarks, and consists of 6.3 million unique features whereof 2.2 million populated places and 1.8 million alternate names. All features are categorized into classes of different scales (county, region, country, . . . ) and further subcategorized into feature codes (size of the city, street, road, name of place, lake, forest, park, . . . ). Another example of location database 35 is the Census database which is provided free of cost by US government for location identification. It is called TIGER database and provides for every location in US (street, city, state . . . ) and its latitude and longitude.

Thanks to such rich information, location indexer can match the content of the crawled pages with any landmark of location repository 35, and extract one or more features corresponding to the type of landmark (street name, region, country, county, park, village, . . . ).

Once a page or document is indexed for landmarks, location indexer 30 stores it in a location index 36, a database, along the identified landmarks.

The system according to the present system comprises also the known features of a keyword indexer 40. Keyword indexer 40, or keyword indexing engine, allows a full text search of all documents and pages crawled and stored in document repository 25. To that effect, an inverted keyword index 45, operatively coupled to keyword indexer 40 is created comprising lists of keywords of each crawled document and pages, along with the number of occurrences, weight for each occurrence in inverted order, . . . . For each word (to the exception maybe of stop words which are too common to be useful) an entry is made in keyword index 45 which lists the exact position of for all its occurrences within the repository of documents. From such a list it is relatively simple to retrieve all the documents that match a query, without having to scan each document. Many search engines incorporate an inverted keyword index when evaluating a search query to quickly locate the documents which contain the words in a query and rank these documents by relevance. Other types of index may be readily used by the man skilled in the art for the keyword indexing.

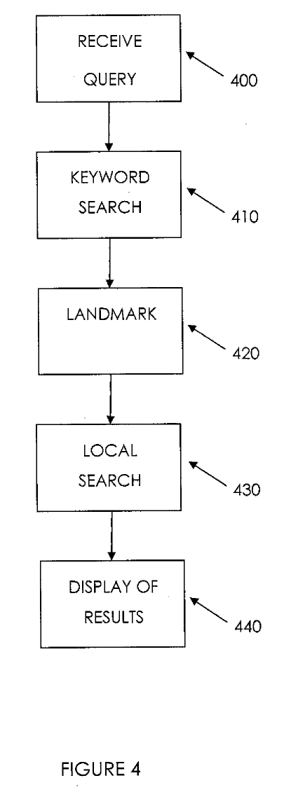

Search engine 50 is the search engine which is built upon the two indexing, i.e. location and keyword indexing. A user may formulate a query comprising any given keyword (i.e. one or more) along with a given landmark (one or more). The query may be formulated in two parts, with one dedicated for the landmark query, or in one single part. In the former case, an interface with 2 separate boxes may be presented to the user to provide both query parts. In the later case, a semantic API (application protocol interface) may be used to sort out in the single query the landmark query from the keyword query. The user may specify one or more landmarks in his/her query. If more than 2 landmarks are specified by the user, the search engine will look into location index 36 for documents linked with these landmarks. An exemplary embodiment of a local search query is illustrated in relation to FIG. 4 and described later on.

Search engine 50 is operatively coupled to location index 36 and keyword index 45. Search engine 50 further comprises a processor 51 to handle a user local search query.

The indexing method according to the present system is illustrated in relation to FIG. 2 with the example of one document. In a preliminary act 200, after a page or document has been crawled and stored into document repository 25, landmarks are searched in the document. The landmarks may be retrieved through the matching in said document of known landmarks from location database 35.

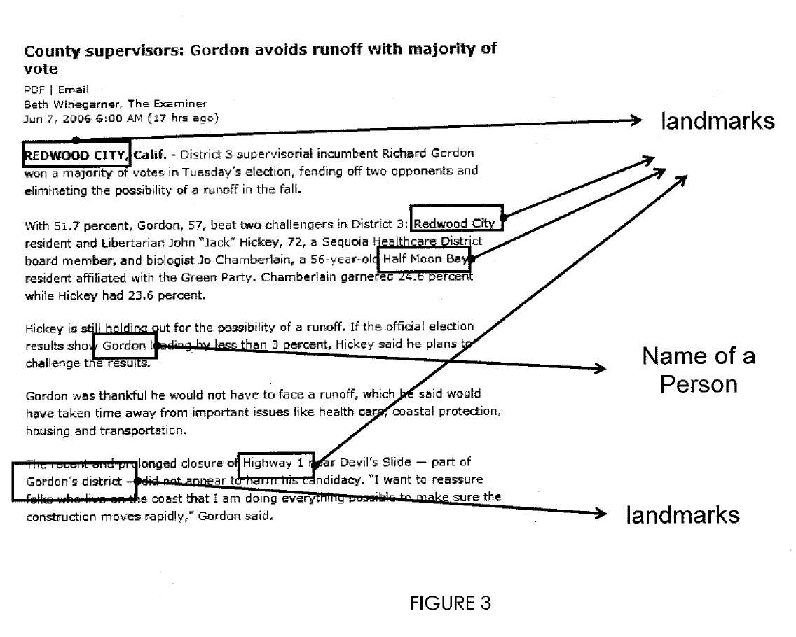

The names used for locations may be sometimes confusing as they may have other meanings. For example, some location names may refer to a city and a first name, like “Paris”, or “Gordon”, as seen in the illustration of FIG. 3. First occurrence of “Gordon” refers to a person's name, while the second is a landmark as it refers to “Gordon's district”. Whether they are actual landmarks (true landmarks) or not (false landmarks) depends upon the context they are used in.

In order to eliminate false landmarks from true ones, a further act 210 is carried out to keep only true landmarks. Location indexer 30 is adapted to automatically extract structured information from the document, i.e. categorized and contextually and semantically well-defined data from a certain domain, herein the geographical domain. Natural Language Processing or NLP may be used to sort out true landmarks from false ones. NLP is a subfield of artificial intelligence and linguistics. It studies the problems of automated generation and understanding of natural human languages. Natural language generation systems convert information from computer databases into normal-sounding human language, and natural language understanding systems convert samples of human language into more formal representations that are easier for computer programs to manipulate.

WSD, or Word Sense Disambiguation, is one problem addressed by NLP, as one word or group of words may have more than one meaning, on our examples, a location meaning and another meaning. Thanks to NLP, and specifically WSD, from the computational linguistic field, true landmark may be identified in the act 210 of the method according to the present system. GATE® (where additional information is provided at http://gate.ac.uk/ie/index.html) is an example of tool which may be used to identify true landmarks. GATE® proposes an information extraction engine which is capable of identify in a document named entities, i.e. places, locations, . . . through its Named Entity Recognition application.

In an additional and option act 220, a semantic analysis is carried out on the document to limit the number of true landmarks. A document may refer to a plurality of unrelated locations. Only some of them are relevant of the actual document content. Act 220 consists in determining the occurrences of the different locations, and based on a semantic analysis of the document content, only retain the landmarks truly related to said content. The discarded landmarks may be seen as simple noisy unrelated to the document.

In a subsequent act 230 of the method according to the present system, weights are assigned to the remaining landmarks from the previous act(s). The weighting may be based on:
the position of the landmark in the document, the closer the landmark to the title, the higher the weight,
the number of occurrences of the landmark,
the type of landmark. As mentioned earlier in relation to location repository 35, landmark may be of different type, for example link to different scales, like a continent, a country, a state, a county, a city, a neighborhood, a street, . . . As the scale gets smaller, the landmark refers to a location more limited in surface. A higher weight is given to landmarks of smaller scale,

Other data may be taken into account to influence the weight associated to each landmark.

Through the U.S. Census Bureau's Census TIGER database mentioned here before, location ontologies are available. They link landmarks of different scales through trees and help identify how a location may be linked to another one in a tree like manner. As defined by the Census Bureau: the design of the Census TIGER® database adapts the theories of topology, graph theory, and associated fields of mathematics to provide a disciplined, mathematical description for the geographic structure of the United States and its territories. The topological structure of the Census TIGER® database defines the location and relationship of streets, rivers, railroads, and other features to each other and to the numerous geographic entities for which the U.S. Census Bureau tabulates data from its censuses and sample surveys. It is designed to ensure that there is no duplication of features or areas.

These ontologies may be extended to all known locations in the world. Thanks to these location ontologies, true landmarks identified in a document may be linked to one another, and only the landmark associated to the smaller scale kept with a higher weight as it is can be seen as a more precise landmark.

In a final act 240, the document is indexed, i.e. stored in location index 36, with one or more true landmarks associated to it. Only the landmarks associated with the highest weights are kept to index the document. In an exemplary embodiment, the landmark associated with the highest weight is kept as representing the document. In an alternative embodiment, a limited number of landmarks is retained. The limited number may be predefined through settings, or a weight threshold may be set before hand, and landmarks with a weight higher than this preset weight may be retained.

When several landmarks are selected to index a document, the weight may also be stored so as to characterize each selected landmark in terms of relevance. For example, the landmark with the highest weight is the most relevant to the content of the document, while the landmark with the lowest weight is less relevant. When a local search is performed, this information may be used to rank the returned hit list be presenting first documents comprising the user specified keywords and indexed with the user specified location with the highest weight.

Different storage methods are readily available to the man skilled in the art to store the landmarks and the associated documents in location index 36. For example, an entry in location index 36 may comprise the document listed first with reference to the landmarks identified for said documents. Inversely, an entry may correspond to a landmark with a link to all documents referencing this landmark. In location index 36, documents are indexed with (or referenced to) one or more landmarks.

The present system also relates to a search engine that searches through the pages and documents indexed with the method according to the present system. The found documents may be displayed on a map centered around the landmark provided in the user's query, the position of all found document being a function of landmarks that reference each found document. In order to obtain geographic coordinates of all landmarks (to define a map centered around the given landmark and position the found documents), the documents may be indexed in the location index 36 with geographic coordinates. Databases like TIGER, the Gazetteer or Geonames, all provide longitude and latitude coordinates of all listed landmarks. The search results may also be positioned on said map.

A local search using the search engine according to the present system is described here after in relation with FIG. 4. In the here after description, the local search is illustrated with a location index 36 comprising documents which are referred with only one landmark. The man skill in the art will easily transpose the here after teachings to a location index wherein the documents are referenced to several landmarks, ranked from most relevant to less relevant. The relevance may be used to return a local search hit list ranking the documents in terms of relevance.

In a first act 400, a user provide a search query, comprising one or more keywords, and at least one landmark that the search results have in common. As mentioned earlier, the landmark and keywords may be provided into one single query and a semantic API will sort out the keywords from the landmark. In an alternative embodiment, both queries, i.e. for keywords and for location, are specified separately.

The user may be interested in searching documents linked to a precise location. He/she then may only specify one single landmark. He/she may on the other hand be interested in a location and its surrounding locations. To that effect, the location query may comprise a distance D to define a neighboring region surrounding the user specified location, so that all locations surrounding the user specified location are taken into account for the local search.

In a subsequent act 410, a keyword search is performed by processor 51 of search engine 50. Any keyword search techniques known by the man skilled in the art may be used at this point. An inverted keyword index, like an inverted keyword index, allows a faster search for relevant documents. With the help of the keyword index 45, search engine 50 returns a list of hits (or hit list), the hits may be sorted out by relevance using known techniques.

In a next act 430, a local search is performed. Documents indexed with the user specified landmark are selected from the hit list. To that effect, the list of hits is reviewed by processor 51 to search for the local documents. When a single location is specified by the user in his/her query, the list of hits is filtered to retain only the documents referenced with the user specified location. Processor 51 retrieve the landmark characterizing each document from the hit list using landmark index 36.

When the user specified landmark is associated to a distance D, a preliminary act 420 may be carried out by processor 51 to characterize the neighboring region surrounding the given landmark. To that effect, the geographic coordinates of landmarks (known from databases like Gazetteer, Geonames, or TIGER cited before) may be used. By searching in location database 35 all locations which are within the neighboring region, a landmark table may be defined, that regroups all the landmarks within the distance D from the user specified landmark. In the subsequent act 420, the hit list from the keyword search is then filtered to retain only the documents referenced with a landmark within the landmark table, i.e. referenced to a landmark within distance D from the user specified landmark.

The result of the filtering in act 420 is a local hit list, comprising all documents that satisfy both the keyword and landmark queries. Act 420 may be carried out right after the query is specified by the user, or at any time preceding the local search act 430.

An alternative way to define the neighboring region would be to use the landmark ontology mentioned earlier and retrieve all landmarks within a given distance D from the user specified landmark which bear a relation (in the ontology trees) with said user specified landmark.

In a subsequent act 440, the results in the local hit list may be presented to the user on a map centered around the user specified landmark, with the positioning of each document from the local hit list as a function of the landmark referencing said document.

The search engine may return a local hit list by performing the local search first, and a subsequent keyword search. The local search then returns a local hit list, and the keyword search leads to a keyword hit list. Both lists are then matched to select common documents which correspond to the final local hit list. Other methods are readily available to the man skilled in the art and are within the scope of this present system.

Obviously, readily discernible modifications and variations of the present location indexer are possible in light of the above teachings. It is therefore to be understood that within the scope of the appended claims, the present system may be practiced otherwise than as specifically described herein. For example, while described in terms of hardware/software components interactively cooperating, it is contemplated that the present system described herein may be practiced entirely in software. The software may be embodied in a carrier such as magnetic or optical disks, or a radio frequency or audio frequency carrier wave.

Thus, the foregoing discussion discloses and describes merely exemplary embodiments of the present system. As will be understood by those skilled in the art, the present system may be embodied in other specific forms without departing from the spirit or essential characteristics thereof. Accordingly, the disclosure of the present system is intended to be illustrative, but not limiting of the scope of the present system, as well as other claims. The disclosure, including any readily discernible variants of the teachings herein, defines, in part, the scope of the foregoing claim terminology such that no inventive subject matter is dedicated to the public.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

What is claimed is:

1. A method for indexing a document comprising the acts of:
retrieving in the content of the document true landmarks associated with said content by matching the content of said document with a landmark database, and using a natural language approach to retain said true landmarks among the identified landmark,
selecting at least one true landmark as representing the document by assigning a weight to each true landmark based on at least one criterion, and selecting said at least one true landmark that represents the document based on the assigned weights, and,
indexing the document to include a reference to the selected at least one true landmark.

2. The method of claim 1, comprising the additional act of indexing the document for keywords.

3. The method of claim 1, wherein the selecting act further comprises a preliminary act of:
performing a semantic analysis of the document content to retain among the retrieved true landmarks the ones most relevant to said content.

4. The method of claim 1, wherein the criterion takes into account at least one of:
the position of the true landmark in the document content,
the number of occurrences of the true landmark in the document content,
the type of the true landmark.

5. The method of claim 3, wherein the type of the true landmark is defined by the scale of said true landmark.

6. The method of claim 1 wherein the reference to the selected at least one true landmark comprises its geographic longitude and latitude.

7. An indexing engine for indexing landmarks to a document, said indexing engine being operatively coupled to a landmark index repository, said landmark indexer being operable to:
retrieve in the content of the document true landmarks associated with said content by matching the content of said document with a landmark database, and using a natural language approach to retain said true landmarks among the identified landmark,
select at least one true landmark as representing the document by assigning a weight to each true landmark based on at least one criterion, and selecting said at least one true landmark that represents the document based on the assigned weights,
index the document in the landmark index repository to include a reference to the selected at least one true landmark

8. The engine of claim 7, wherein the indexing engine is further operable to perform a semantic analysis of the document content to retain among the retrieved true landmarks the ones most relevant to said content.

9. The engine of claim 7, wherein the criterion takes into account at least one of:
the position of the true landmark in the document content,
the number of occurrences of the true landmark in the document content,
the type of the true landmark.

10. The engine of claim 9, wherein the type of the true landmark is defined by the scale of said true landmark.

11. The engine of claim 6, wherein the reference to the selected at least one true landmark comprises its geographic longitude and latitude.

12. A computer readable carrier including computer program instructions that cause a computer to implement a method for indexing a document, said computer readable carrier comprising:
instructions for retrieving in the content of the document true landmarks associated with said content by matching the content of said document with a landmark database, and using a natural language approach to retain said true landmarks among the identified landmark,
instructions for selecting at least one true landmark as representing the document by assigning a weight to each true landmark based on at least one criterion, and selecting said at least one true landmark that represents the document based on the assigned weights, and,
instructions for indexing the document to include a reference to the selected at least one true landmark.

13. The carrier of claim 12, further comprising instructions for performing a semantic analysis of the document content to retain among the retrieved true landmarks the ones most relevant to said content.

14. The carrier of claim 12, further comprising instruction to take into account for the weight assignment at least one of:
the position of the true landmark in the document content,
the number of occurrences of the true landmark in the document content,
the type of the true landmark.

15. The carrier of claim 12, the reference to the selected at least one true landmark comprises its geographic longitude and latitude

16. A search engine to identify documents both linked to a given landmark and satisfying a given search query from a plurality of documents, said architecture comprising:
a keyword indexing engine for generating a keyword indexing of the plurality of documents,
a landmark indexing engine operable, for each document, to:
retrieve in the content of the document true landmarks associated with said document by matching the content of said document with a landmark database, and using a natural language approach to retain said true landmarks among the identified landmark,
select at least one true landmark as representing the document by assigning a weight to each true landmark based on at least one criterion, and selecting said at least one true landmark that represents the document based on the assigned weights,
the landmark indexing engine being further operable to generate a landmark indexing for the plurality of documents by indexing each document with a reference to the selected at least one true landmark for said document,
a processor operable to identify the documents linked to the given landmark from the landmark indexing and satisfying the given search query from the keyword indexing.

17. The search engine of claim 16, wherein the processor is further operable to:
retrieve the list of documents that satisfy the given search query,
select among the list of documents local documents that are referenced in the landmark indexing with at least one true landmark identical to the given landmark.

18. The search engine of claim 16, wherein the query further comprises a distance to define a neighboring region around the given landmark, the processor being further operable to:
retrieve the list of documents that satisfy the given search query,
select among the list of documents local documents that are referenced in the landmark indexing with at least one true landmark located within the neighboring region.

19. A processor configured to identify documents both linked to a given landmark and satisfying a given search query from a plurality of documents, said processor comprising:
a portion configured to generate a keyword indexing of the plurality of documents,
a portion operable, for each document, to:
retrieve in the content of the document true landmarks associated with said document by matching the content of said document with a landmark database, and using a natural language approach to retain said true landmarks among the identified landmark,
select at least one true landmark as representing the document by assigning a weight to each true landmark based on at least one criterion, and selecting said at least one true landmark that represents the document based on the assigned weights,
said portion being further operable to generate a landmark indexing for the plurality of documents by indexing each document with a reference to the selected at least one true landmark for said document,
a portion operable to identify the documents linked to the given landmark from the landmark indexing and satisfying the given search query from the keyword indexing.

20. The processor of claim 19, wherein the processor further comprises:
a portion to retrieve the list of documents that satisfy the given search query,
a portion to select among the list of documents local documents that are referenced in the landmark indexing with at least one true landmark identical to the given landmark.

21. The processor of claim 19, wherein the query further comprises a distance to define a neighboring region around the given landmark, the processor further comprising:
a portion to retrieve the list of documents that satisfy the given search query,
a portion to select among the list of documents local documents that are referenced in the landmark indexing with at least one true landmark located within the neighboring region.
